(19) United States
(12) Patent Application Publication
(10) Pub. No.: US 2018/0207454 A1
(43) Pub. Date: Jul. 26, 2018

(54) Breath Diverting Mask Assembly

(71) Applicant: Edmund Eilermann, St. Louis, MO (US)

(72) Inventor: Edmund Eilermann, St. Louis, MO (US)

(21) Appl. No.: 15/416,432

(22) Filed: Jan. 26, 2017

(51) Int. Cl. A62B 18/02; A62B 18/08

(52) U.S. Cl. CPC A62B 18/025; A62B 18/08

(57) ABSTRACT

A breath diverting mask assembly for inhibiting condensation from forming on a windshield includes a mask that is selectively worn when a vehicle is driven. An exhaust unit is fluidly coupled to the mask to direct exhaled breath away from a windshield in the vehicle. In this way the exhaled breath is inhibited from condensing on the windshield thereby promoting unobstructed vision through the windshield.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to mask devices and more particularly pertains to a new mask device for inhibiting condensation from forming on a windshield.

### BRIEF SUMMARY OF THE INVENTION

An embodiment of the disclosure meets the needs presented above by generally comprising a mask that is selectively worn when a vehicle is driven. An exhaust unit is fluidly coupled to the mask to direct exhaled breath away from a windshield in the vehicle. In this way the exhaled breath is inhibited from condensing on the windshield thereby promoting unobstructed vision through the windshield.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a breath diverting mask assembly according to an embodiment of the disclosure.

FIG. 2 is a front view of an embodiment of the disclosure.

FIG. 3 is a bottom view of an exhaust unit of an embodiment of the disclosure.

FIG. 4 is a right side view of an embodiment of the disclosure.

FIG. 5 is a back view of an embodiment of the disclosure.

### DETAILED DESCRIPTION OF THE INVENTION

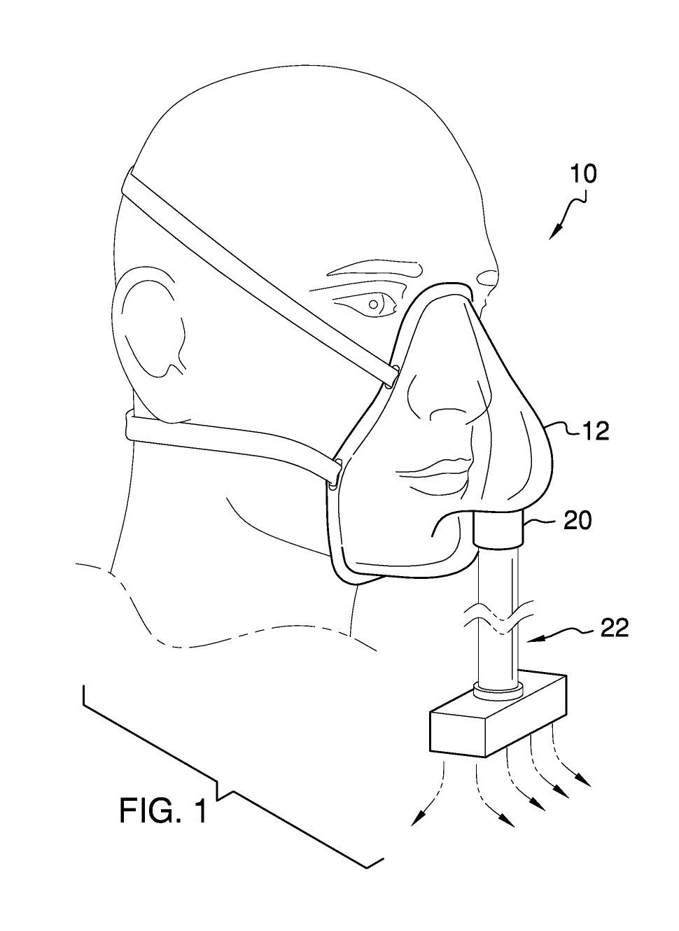

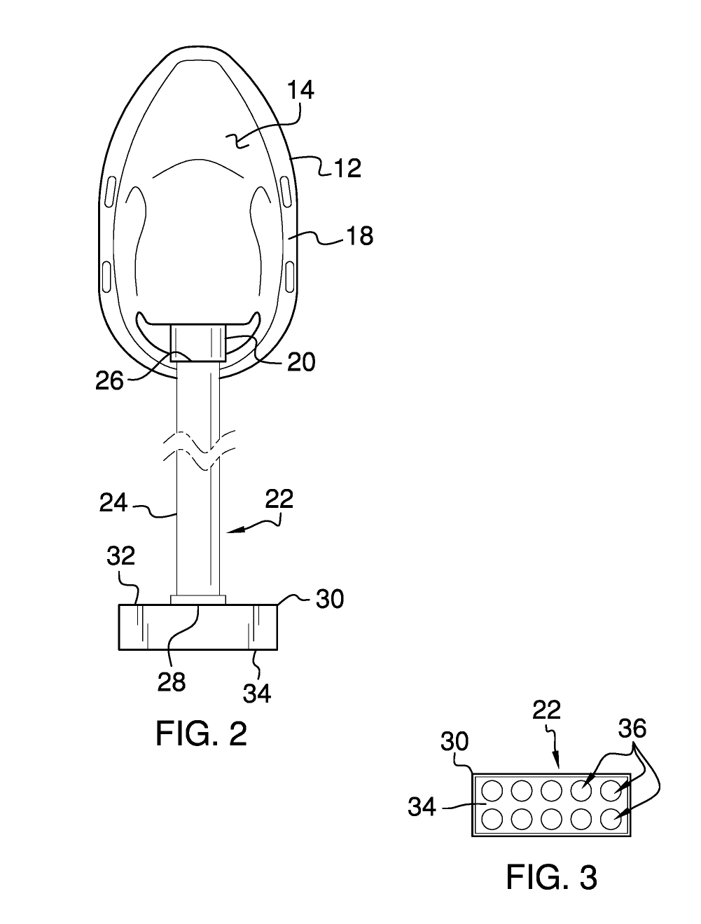

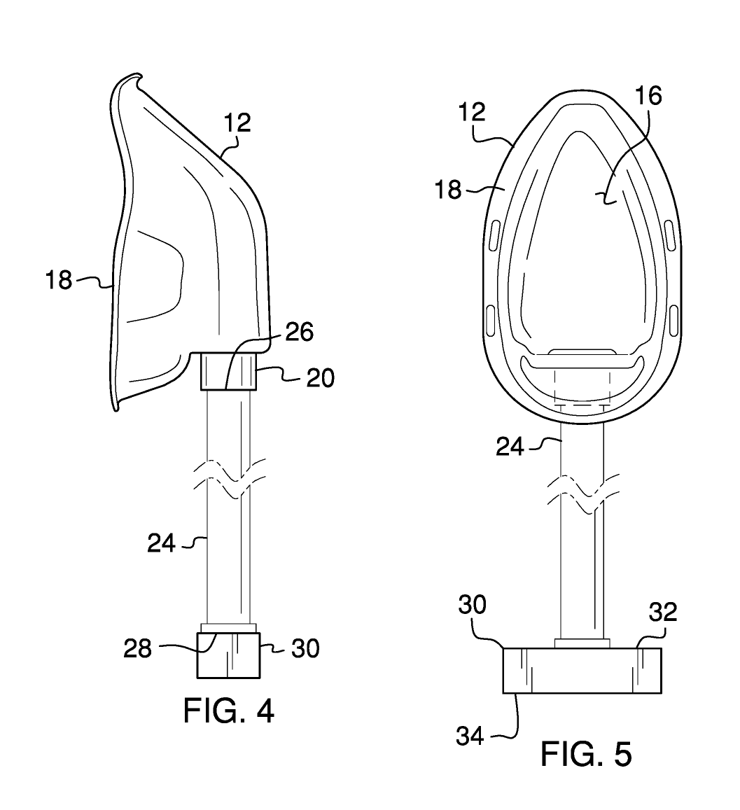

With reference now to the drawings, and in particular to FIGS. 1 through 5 thereof, a new mask device embodying the principles and concepts of an embodiment of the disclosure and generally designated by the reference numeral 10 will be described.

As best illustrated in FIGS. 1 through 5, the breath diverting mask assembly 10 generally comprises a mask 12 that may be worn when a vehicle is driven. The vehicle may be a passenger vehicle or the like and the vehicle has a windshield. The mask 12 has a first surface 14, a second surface 16 and a peripheral edge 18 extending therebetween. Each of the first surface 14 and the second surface 16 is concavely arcuate with respect to the peripheral edge 18. Thus, the mask 12 forms a cup to surround a nose and a mouth when the mask 12 is worn. An exhaust port 20 extends through the first surface 14 and the second surface 16 to direct exhaled breath outwardly from the mask 12. A pair of straps may be provided and each of the straps may be coupled to the mask 12 to retain the mask 12 on a user.

An exhaust unit 22 is provided and the exhaust unit 22 is fluidly coupled to the mask 12. The exhaust unit 22 directs the exhaled breath away from the windshield in the vehicle. In this way the exhaled breath is inhibited from condensing on the windshield when the vehicle is being driven in a cold environment. Thus, visibility through the windshield is not obscured by the condensation on the windshield.

The exhaust unit 22 comprises a tube 24 that has a first end 26 and a second end 28. The first end 26 is fluidly coupled to the exhaust unit 22 to direct the exhaled breath outwardly from the second end 28. A box 30 is provided that has a top wall 32 and a bottom wall 34. The top wall 32 is fluidly coupled to the second end 28 of the tube 24 to receive the exhaled breath. The bottom wall 34 has a plurality of openings 36 and each of the openings 36 extends into an interior of the box 30. Moreover, each of the openings 36 directs the exhaled breath downwardly with respect to the mask 12. In this way the exhaled breath is diverted away from the windshield.

In use, the mask 12 is worn when the vehicle is being driven in a cold environment and a heating system in the vehicle has not reached normal operating temperature. The exhaust tube 24 directs the exhaled breath into the box 30. The openings 36 in the box 30 direct the exhaled breath downwardly with respect to the mask 12. In this way the exhaled breath is inhibited from being directed onto the windshield and condensing on the windshield. Thus, the mask 12 facilitates a clear view through the windshield until the heating system in the vehicle reaches normal operating temperature.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A breath diverting mask assembly being configured to inhibit exhaled breath from forming fog on a windshield, said assembly comprising:
a mask being configured to be worn when a vehicle is driven; and
an exhaust unit being fluidly coupled to said mask wherein said exhaust unit is configured to direct the exhaled breath away from a windshield in the vehicle thereby inhibiting the exhaled breath from condensing on the windshield.

2. The assembly according to claim 1, wherein said mask has a first surface, a second surface and a peripheral edge extending therebetween, each of said first surface and said second surface being concavely arcuate with respect to said peripheral edge such that said mask forms a cup wherein said mask is configured to surround a nose and a mouth when said mask is worn.

3. The assembly according to claim 2, wherein said mask has an exhaust port extending through said first surface and said second surface wherein said exhaust port is configured to direct exhaled breath outwardly from said mask.

4. The assembly according to claim 1, wherein:
said mask has an exhaust port; and
said exhaust unit comprises a tube having a first end and a second end, said first end being fluidly coupled to said exhaust unit wherein said tube is configured to direct the exhaled breath outwardly from said second end.

5. The assembly according to claim 4, further comprising a box having a top wall and a bottom wall, said top wall being fluidly coupled to said second end of said tube wherein said box is configured to receive the exhaled breath.

6. The assembly according to claim 5, wherein said bottom wall has a plurality of openings, each of said openings extending into an interior of said box wherein each of said openings is configured to direct the exhaled breath downwardly with respect to said mask.

7. A breath diverting mask assembly being configured to inhibit exhaled breath from forming fog on a windshield, said assembly comprising:
a mask being configured to be worn when a vehicle is driven, said mask having a first surface, a second surface and a peripheral edge extending therebetween, each of said first surface and said second surface being concavely arcuate with respect to said peripheral edge such that said mask forms a cup wherein said mask is configured to surround a nose and a mouth when said mask is worn, said mask having an exhaust port extending through said first surface and said second surface wherein said exhaust port is configured to direct exhaled breath outwardly from said mask; and
an exhaust unit being fluidly coupled to said mask wherein said exhaust unit is configured to direct the exhaled breath away from a windshield in the vehicle thereby inhibiting the exhaled breath from condensing on the windshield, said exhaust unit comprising:
a tube having a first end and a second end, said first end being fluidly coupled to said exhaust unit wherein said tube is configured to direct the exhaled breath outwardly from said second end, and
a box having a top wall and a bottom wall, said top wall being fluidly coupled to said second end of said tube wherein said box is configured to receive the exhaled breath, said bottom wall having a plurality of openings, each of said openings extending into an interior of said box wherein each of said openings is configured to direct the exhaled breath downwardly with respect to said mask.
